(19) United States
(12) Patent Application Publication
(10) Pub. No.: US 2016/0094439 A1
(43) Pub. Date: Mar. 31, 2016

(54) METHOD AND APPARATUS FOR INTERFACE CAPABILITY AND ELASTIC CONTENT RESPONSE ENCODING IN INFORMATION CENTRIC NETWORKING

(71) Applicant: Futurewei Technologies, Inc., Plano, TX (US)

(72) Inventors: Ravishankar Ravindran, San Ramon, CA (US); Guoqiang Wang, Santa Clara, CA (US); Asit Chakraborti, Pleasanton, CA (US); Aytac AZGIN, Santa Clara, CA (US)

(21) Appl. No.: 14/842,667

(22) Filed: Sep. 1, 2015

Related U.S. Application Data
(60) Provisional application No. 62/056,354, filed on Sep. 26, 2014.

(51) Int. Cl. H04L 12/773; H04L 12/805

(52) U.S. Cl. CPC H04L 45/60; H04L 47/36

(57) ABSTRACT

A method for state based forwarding using an embedded flag in the type length values (TLV) architecture of information centric network (ICN) interfaces, the method comprises storing, in static and dynamic fashions forward information for ICN router interfaces, the stored information is stored in a pending interest table (PIT) table associated with the ICN router interface. Next, using, a flag within the stored information in the TLV architecture of the ICN router interface wherein the flag is associated with an interest capability of the ICN router interface. Further, receiving, an interest associated with flag for forwarding at the ICN router interface, and checking, the received interest with the stored information in the PIT table of the ICN router interface for forwarding to a content source.

### CROSS-REFERENCE TO RELATED U.S. APPLICATION

The present application claims priority to U.S. Provisional Application No. 62/056,354, entitled “METHOD AND APPARATUS FOR INTERFACE CAPABILITY AND ELASTIC CONTENT RESPONSE ENCONDING IN INFORMATION CENTRIC NETWORKING,” filed on Sep. 26, 2014, naming the same inventors as in the present application. The contents of the above-referenced provisional application are incorporated by reference, the same as if fully set forth herein.

### TECHNICAL FIELD

Embodiments of the present invention generally relate to embedding a flag in an ICN router interface for faster propagating of interests to the destination content sources. More specifically, embodiments of the present invention utilize an elastic type length value architecture to assess payloads associated with interests for routing on ICN interfaces.

### BACKGROUND OF INVENTION

In content centric networks (CCN), users request named content packets by issuing interest packets and receiving the corresponding data packets. Routers propagate interest packets toward the appropriate content sources and store the corresponding information for each respective forwarded Interest packet in a Pending Interest Table (PIT). When data arrives, routers push them towards a respective requester based on the information stored in the PIT. If incoming data has no match in the PIT, a router will consider the data as unwanted traffic and immediately discards it.

Tracking each forwarded interest packet, however, raises scalability concerns. Per-packet forwarding states can be avoided by adopting a stateless forwarding mechanism in which interest packets gather path information on their way to the content source and data is then source-routed by reversing the gathered path information. The removal of forwarding states, however, nullify the advantages of CCN forwarding because routers cannot aggregate interests or duplicate data, thereby providing less support for multicasts. Furthermore, routers cannot drop unwanted packets because state forwarding is removed and adaptive forwarding is disabled.

The maximum transmission unit (MTU) specifies the largest packet size, including headers and data payload that can be transmitted by the link-layer technology. If an end-to-end connection uses a MTU larger than the link MTU, the packet will either be fragmented or dropped. Hence, using larger MTUs can sometimes be detrimental to performance when it causes fragmentation because every fragment must have an additional set of headers. To prevent this from occurring, there are mechanisms to discover the MTU of a network path in such end-to-end connections. A new Path MTU (PMTU) discovery mechanism is used to dynamically discover the path's MTU. This new mechanism specifies an alternative way to probe end-to-end MTUs by sending progressively larger packets end-to-end across all the link layer technologies.

Jumbo frame transfers require support for jumbo packet size in all the network devices along the communication path. Jumbo frames need to be configured in order to correlate the ingress and egress interfaces of each device along the end-to-end transmission path. Furthermore, all devices in the topology should correlate to the maximum jumbo frame size. If there are devices along the transmission path that have varying frame sizes, there may be fragmentation issues. Additionally, if a device along the path does not support jumbo frames, but nevertheless device receives a jumbo frame, the result will be that the jumbo frame is dropped by the device due to its inability to support the frame. In the past, when deploying a CCN architecture, CCNx1.0 proposes end-to-end fragmentation based on path MTU discovery to aid fragmentation. This means that fragmentation and re-assembly would occur at the CCN layer and the higher level applications would not be involved in the fragmentation and reassembly steps.

Hence, a need exists to develop mechanisms that adapt or utilize the heterogeneous interface capabilities of communication networks and end devices so that large size video blocks, for instance, can be transferred if the MTU allows such transfer across the network and the end devices. Also, a need exists for a more simplistic TLV architecture for enabling large size content transfer operations rather than MTU discovery for having packet fragmentation. Furthermore, a need exists to generate content responses to aid planned networks in supporting high data rates and to amortize the overhead control of high data rate supported networks.

### SUMMARY OF THE INVENTION

Embodiments of the present invention use embedded flags in the TLV architecture to enable the signaling of very high MTU end-to-end transfers. Embodiments of the present invention, by using an elastic TLV data structure for adaptive content responses from the application end, enable more efficient encoding structures compared to conventional TLV defined data structures. Moreover, embodiments of the present invention also provide multiple types of TLV sizes that result in improved parsing complexity and can overcome the drawbacks of simpler fixed structures inflexibilities and which also enable embodiments of the present invention to better adapt to variable content responses.

More specifically, in one embodiment, the present invention is implemented as a method for state based forwarding using an embedded flag in the type length values (TLV) architecture of information centric network (ICN) interfaces. The method includes storing, in static and dynamic fashions forward information for ICN router interfaces, the information in a pending interest table (PIT) table associated with the ICN router interface. The method also includes using a flag within the stored information in the TLV architecture of the ICN router interface wherein the flag is associated with an interest capability of the ICN router interface.

Additionally, the method includes receiving an interest associated with flag for forwarding at the ICN router interface. Also, the method includes checking the received interest with the stored information in the PIT table of the ICN router interface by using the flag associated with the interest to determine if the received interest matches a value of a flag of the PIT table associated to an interest. Furthermore, the method includes forwarding the received interest if there exist no similar matching value in the PIT table to a content source.

In another embodiment, the present invention is implemented as a computer program product embodied in hardware and comprising non-transitory functional descriptive material imparting functionality to a computer, and which when executed by the computer, causes the computer to perform actions for a state based forwarding process using an embedded flag in the type length values (TLV) architecture of information centric network (ICN) interfaces. The method includes storing, in static and dynamic fashions forward information for ICN router interfaces, the stored information in a pending interest table (PIT) table associated with the ICN router interface. The method also includes using a flag within the stored information in the TLV architecture of the ICN router interface wherein the flag is associated with an interest capability of the ICN router interface.

The method also includes receiving an interest associated with flag for forwarding at the ICN router interface. The method also includes checking the received interest with the stored information in the PIT table of the ICN router interface by using the flag associated with the interest to determine if the received interest matches a value of a flag of the PIT table associated to an interest. Furthermore, the method includes forwarding the received interest if there exist no similar matching value in the PIT table to a content source.

In another embodiment, the present invention is implemented as a data processing system comprising at least one processor; data storage accessible to the at least one processor; and a set of instructions in the data storage, wherein the at least one processor is operable to execute the set of instructions to perform actions for state based forwarding using an embedded flag in the type length values (TLV) architecture of information centric network (ICN) interfaces. The method includes storing in static and dynamic fashion forward information for ICN router interfaces, the stored information in a pending interest table (PIT) table associated with the ICN router interface. The method also includes using a flag within the stored information in the TLV architecture of the ICN router interface wherein the flag is associated with an interest capability of the ICN router interface. Furthermore, the method includes receiving an interest associated with flag for forwarding at the ICN router interface, and checking, the received interest with the stored information in the PIT table of the ICN router interface by using the flag associated with the interest to determine if the received interest matches a value of a flag of the PIT table associated to an interest. Furthermore, the method includes forwarding the received interest if there exist no similar matching value in the PIT table to a content source.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a system having heterogeneous interfaces, according to an embodiment of the present invention.

FIG. 2 shows a diagram of interface capability marking at source/intermediate nodes according to an embodiment of the present invention.

FIG. 3 shows a diagram of marking interests according to an embodiment of the present invention.

FIG. 4 is a diagram of exemplary packet formats capable of adjusting to different payload sizes in accordance with embodiments of the present invention.

FIGS. 5A-C show exemplary elastic TLV architectures according to an embodiment of the present invention.

FIG. 6 shows a diagram of managing the face marking network deployment according to an embodiment of the present invention.

FIG. 7 is a diagram that shows exemplary caching implications of intermediate nodes according to an embodiment of the present invention

FIG. 8 is a flowchart that shows an exemplary process of relating interests in the elastic TLV architecture according to an embodiment of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternatives, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying”, “marking”, “selecting” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

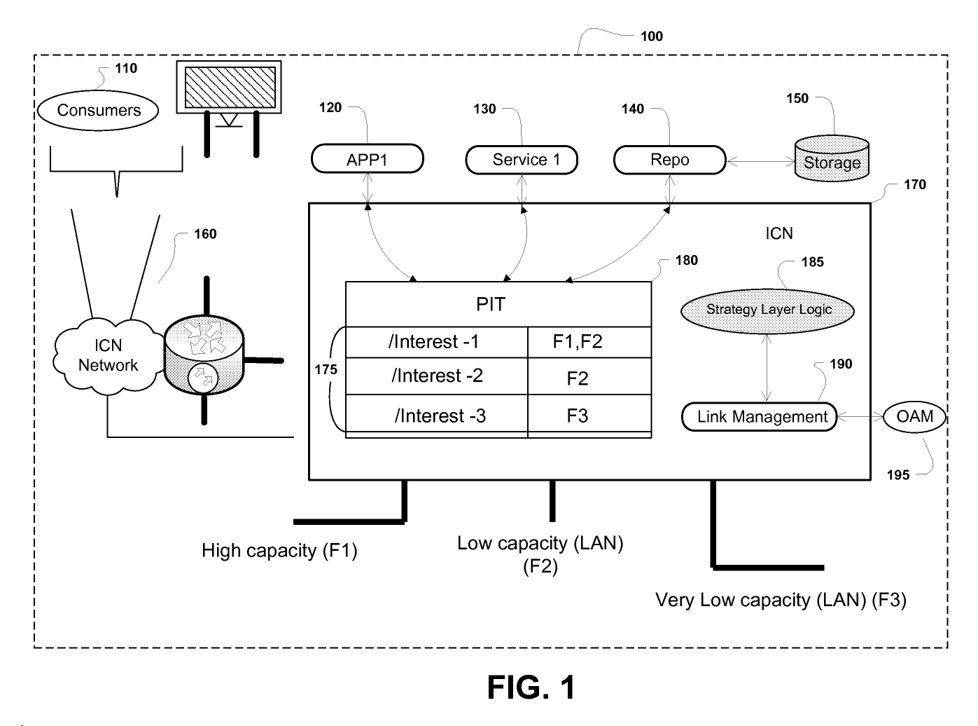

Embodiments of the present invention are generally directed to the interface capabilities for signaling and elastic content response encoding in ICN. In FIG. 1, a system (100) having a heterogeneous face with consumers (110), ICN networks (160), and APP1 marker segment (120), Service 1 (130), Repo (140), storage (150) and an ICN (170) is illustrated in accordance with embodiments of the present invention. Furthermore, in FIG. 1, the ICN (170) has PIT table (180) with the registered interests for receiving bidirectional inputs from APP1 (120), Service 1 (130), and Repo (140) and having outputs of high capacity F1, low capacity (LAN) (F2) and very low capacity (LAN) (F3). The PIT is a central component in CCN node because it is involved in the processing of every message. The role of a PIT table is to store the request (e.g., Interest) packets that passed through a CCN node until these Interests are “fulfilled” by the reception of matching response (data) packets. For every reception of Interest packets, the PIT table should create or update an entry which contains the Interest names and the incoming router interface (e.g., face).

For every data packet, the router uses the PIT table to find out the outgoing faces and then deletes the entries. First, there is the assumption of face capabilities of FIG. 1 based on markings at the end device, markings at the intermediate device and markings at the end routers. Next, the strategy layer logic (185) linked to the management (190) of the face is aware of the available interfaces (100) and can flag the faces with capabilities such as sustaining very large MTU (e.g. the i/f could for example have high capacity fiber that extends to the length to the residential units). Hence, by the strategy layer logic (185), the discovery of such high bandwidth paths is enabled and the interface allows elastic content responses by ascertaining the capabilities of the nodes in advance. Therefore, high bandwidth paths are determined and elastic content responses are enabled. Finally, those interests (175) with the MTU class are mapped to the appropriate segments, e.g., high capacity (F1), low capacity (F2), and very low capacity (F3) network segments.

By using a route-by-name principle as opposed to source and destination addresses, the CCN can determine the interest and content packets identified by names composed of one or more name components. Whenever a client requests information, the client will send out an interest containing a name describing the desired information. Subsequent nodes for that interest are traversed through hop-by-hop routing until the interest reaches the node that satisfies the description of the interest.

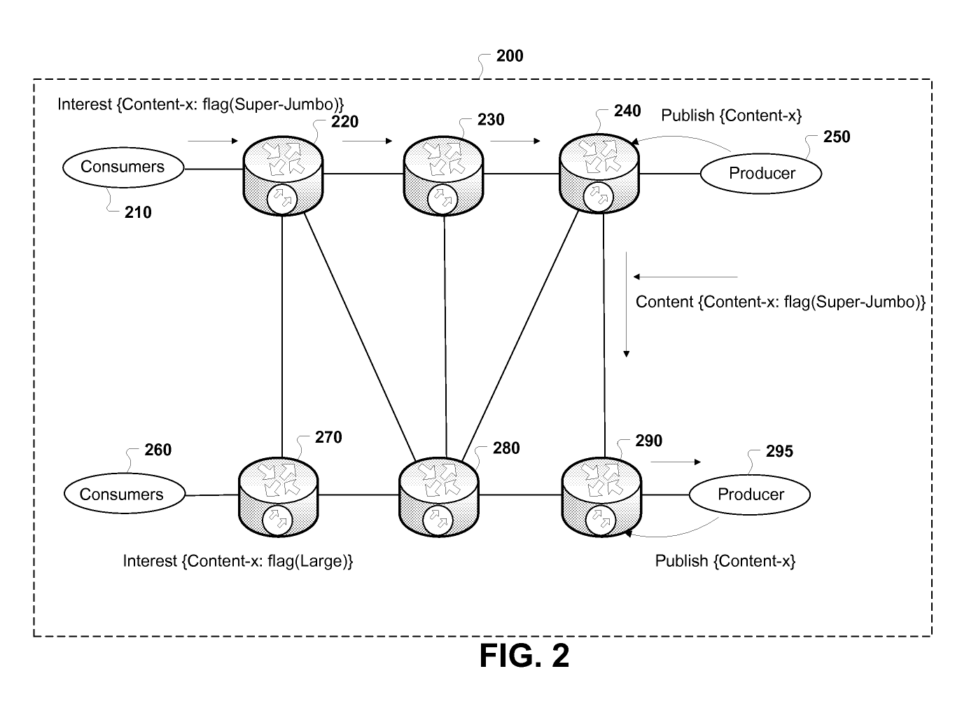

FIG. 2 shows the hop-by-hop sequence of an interest being forwards and the flag for determining the throughput of a network segment in accordance with embodiments of the present invention. In FIG. 2, topology (200) of the interface capability markings at source and intermediate nodes is depicted. As illustrated in FIG. 2, consumers (210) having interest markings of interest {Content-x:flag(super-jumbo)} where the super-jumbo flagged content traverse a path from intermediate nodes (220) to intermediate node (230) to intermediate node (240) and then to intermediate node (290) to producer (295) as publish {Content-x}. As shown in FIG. 2, the segment from intermediate node (240) to intermediate node (290) is marked with the content {content-x:flag(super-jumbo)}. It is appreciated that the segments between the intermediate nodes (220) to (230), the segment from intermediate node (230) to (240), and the segment from intermediate node (240) to (290) support the content {content-x:flag(super-jumbo)}. The content {content-x:flag(super-jumbo)} bypasses the segments coupled to the intermediate nodes (270) and (280) as these intermediate node segments do not support the Super-Jumbo type MTUs. It is also appreciated that the source flags of interest of the consumers (210) and (260) with the “flag” marking (e.g.“super jumbo”, “jumbo”, “large”, “default”, etc.) enable path discovery mechanisms for the path to support the specified content {content-x:flag(super-jumbo)}. Additionally, intermediate nodes can also be marked with particular interfaces so that interests with the MTU class marking can be mapped to the appropriate interface. Furthermore, by having the flag marking, there is a differentiation between paths of different capacities as in super-jumbo, jumbo, large and default by the MTU type markings. Intermediate nodes can use the strategy layer to map the interest to the corresponding interface towards the producers. If interest is sent over an interface which does not match the interest flag, then it may revert to the path from an MTU discovery mechanism or end up in a fragmentation.

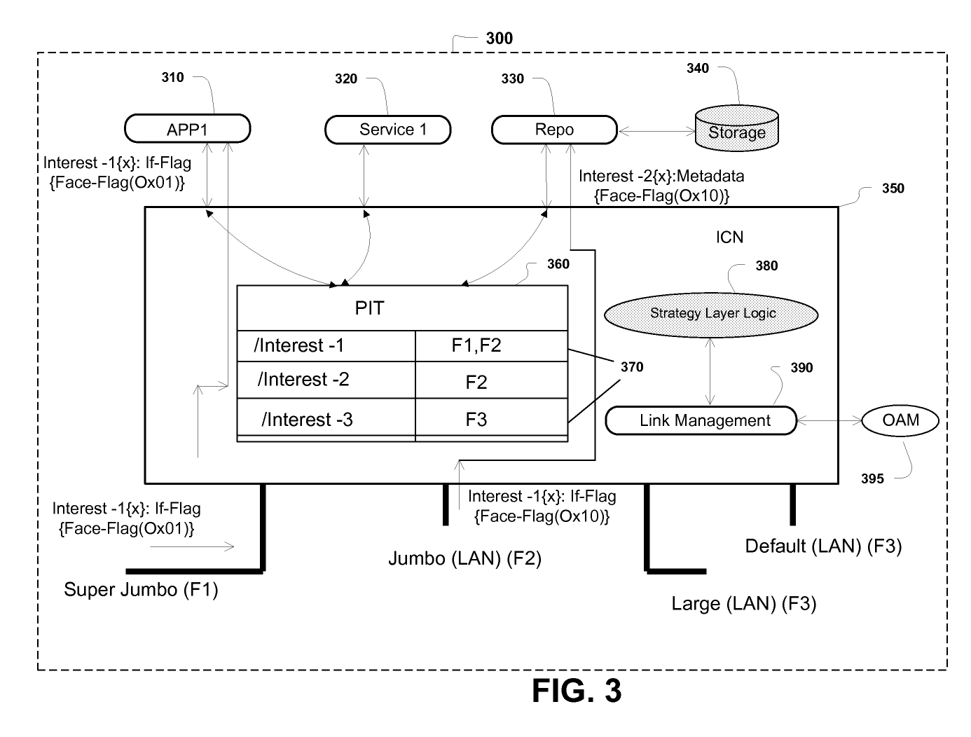

FIG. 3 shows an interface (300) where the interests (interest-1(x), interest-2(x)) can be marked locally with the face capability which allows applications to create content responses in accordance with embodiments of the present invention. As illustrated in FIG. 3, APP1 (310) receives the interest-1 {x}:if-Fla {face-Flag(OxO1)} received from the superjumbo (F1) and then either forwards or receives the interest-1 {x}:if-Fla {face-Flag(OxO1)} to the PIT table (360) with the registered interests. The Service 1 source (320) is bi-directionally coupled to the PIT (360) as is the REPO source (330) and to the storage (340). The ICN content router (350) contains the interest-1,2,3 (370) in the PIT table (360) attached to the interests (370). In the PIT table (360) the interests -1,-2, -3 (370) are organized with the MTU capabilities of the segments F1, F2 and F3. For example, in table (360), interest-1 is associated with super jumbo (F1) and jumbo (F2). Hence, the forward direction of interest-1{x} would be along the F1 and F2 segment. Additionally, interest packets can be forwarded with respect to the priorities of addressed content. The priority level settings can be performed by content publishers during an initialization phase using a collaborative mechanism of exchanging messages to agree to the priority levels of all content according to the content-nature.

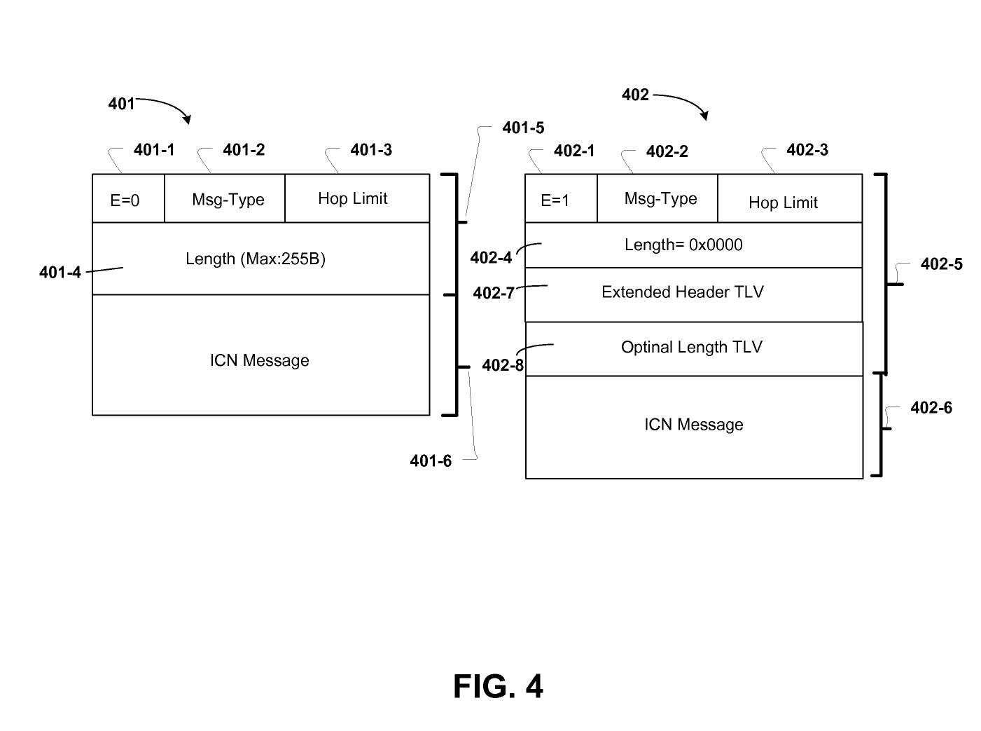

FIG. 4 is a diagram of exemplary packet formats capable of adjusting to different payload sizes in accordance with embodiments of the present invention. FIG. 4 illustrates how embodiments of the present invention can adjust payloads to facilitate the storage of both smaller loT content as well as larger MTUs. For instance, as depicted in FIG. 4, exemplary packet (401) is formatted as an elastic PDU TLV packet which can store smaller loT friendly message content such as ICN message (401-6). According to one embodiment, ICN message (401-6) can include data related to an interest, name, i/f flag and/or metadata. Elastic PDU packet (401) can include header information such as Extended header flag (E) (401-1), message type (401-2) and hop limit (401-3). Elastic PDU packet (401) also includes variable length payload (401-4) which can be configured for different payload sizes. Although FIG. 4 depicts variable length payload (401-4) as storing 255B, it should be appreciated that embodiments of the present invention are not limited to 255B and may include different variable length payload sizes. In this fashion, flag (401-1), message type (401-2) and/or hop limit (401-3) can represent a fixed header portion (401-5) of elastic PDU packet (401). For instance, in one embodiment, flag (401-1) can be configured to store 1 bit of data, message type (401-2) can be configured to store 3 bits of data and hop limit (401-3) can be configured to store 4 bits of data.

Furthermore, as depicted in FIG. 4, packet (402) represents an elastic PDU TLV packet which can store larger MTUs such as ICN message (402-6). As illustrated in FIG.4a, flag (402-1) can be a boolean value adjusted to represent the storage of larger MTU messages. As such, setting flag (402-1) to a value of “1” provides notification to a device consuming elastic PDU packet (402) that it includes larger MTU content. For instance, as depicted in FIG. 4, the adjustment of flag (402-1) can indicate an increased variable length payload (402-4) through the inclusion of additional TLV fields, such as extended header TLV (402-6) and optional length TLV (402-7). Furthermore, in this manner, flag (402-1), message type (402-2), hop limit (402-3), extended header TLV (402-6) and/or optional length TLV (402-7) can represent a fixed header portion (402-6) of elastic PDU packet (402) that includes extended header data.

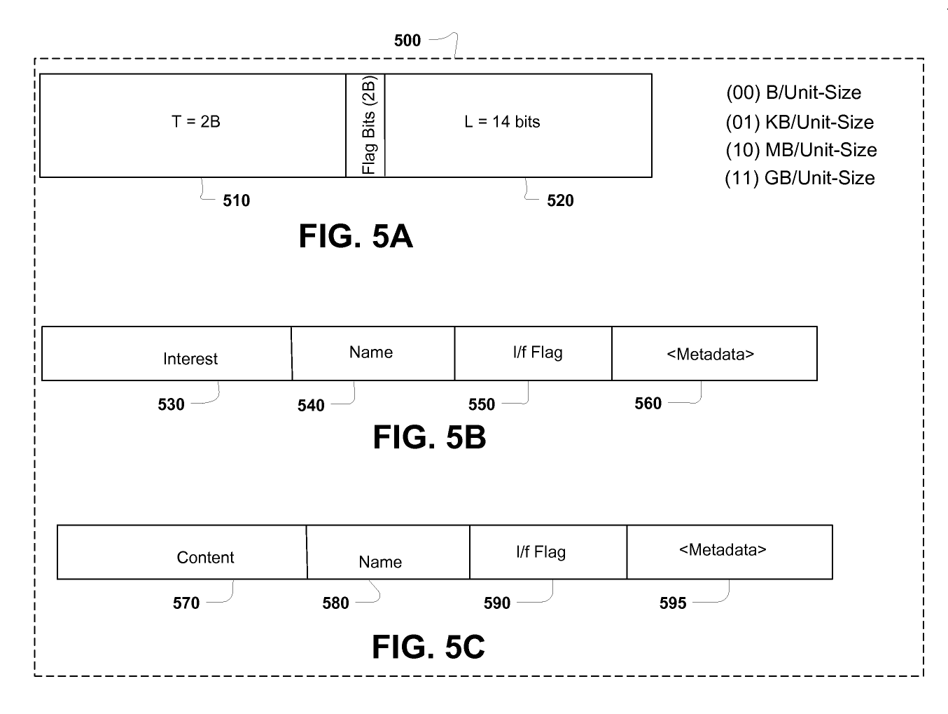

FIGS. 5A-C depict examples of the elastic TLV in accordance with embodiments of the present invention. Variable “Length” definitions to accommodate heterogeneous application device interface capability contexts are shown (e.g. Optical, loT in FIGS. 5A-C). FIG. 5A depicts an exemplary encoded content payload in accordance with embodiments of the present invention. As shown in FIG. 5A, the length of the data structure (500) is relatively straight forward in terms of limiting overhead to 2/2 type (510) and, likewise the length (520), and additionally using two bits to determine the granularity of the payload (flag bits (2 b)). The 2 bits are embedded elastic TLV architecture and are associated with a payload. For example, (00) B/Unit-size, (01) KB unit-Size, (10) MB/Unit Size and (11) GB/Unit-size. The selection of the per unit resolution is determined by the application based on feedback from the ICN forwarding layer.

Additionally, FIGS. 5B-C depict an exemplary encoded interest and content in accordance with embodiments of the present invention. FIGS. 5B-C show context handling such as the interest (530) with the i/f flag (550) and the metadata (560). Here, there is provision to include context metadata that can be processed in the Network Layer. For example:
Contexts include Identity/Location/Device etc.
Attachment to a Service Instance
Discovering Content/Services
Policy based Routing/Forwarding

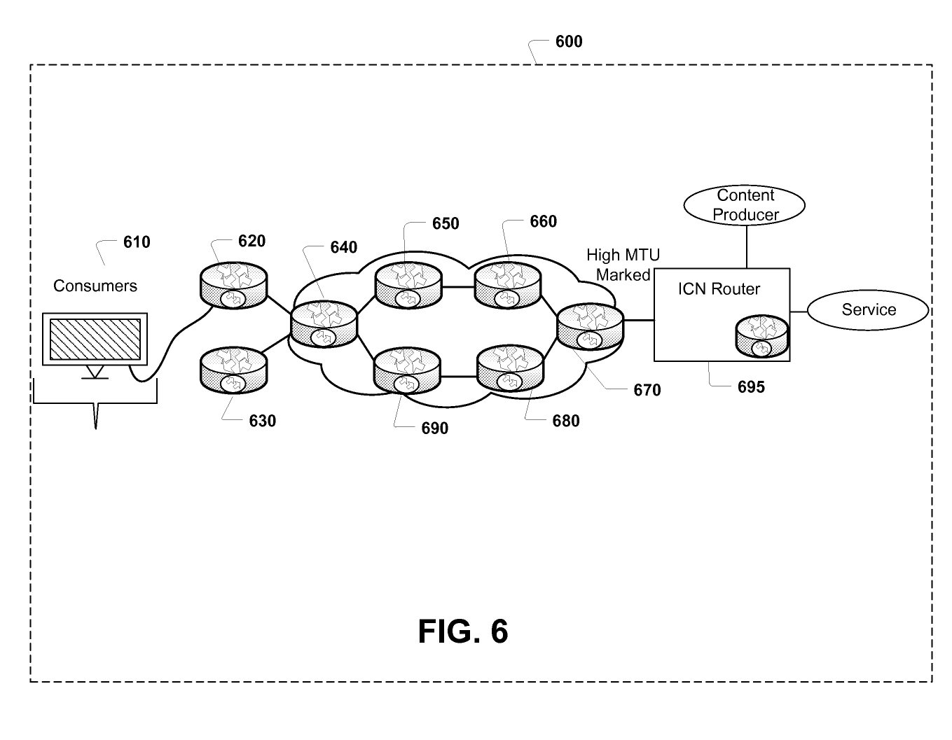

FIG. 6 shows a diagram illustrating examples of managing the interface markings in a network in accordance with embodiments of the present invention. In FIG. 5, the source consumer (610) in coupled through a series of intermediate nodes (620-670) to the ICN router (695). The intermediate nodes are local (620, 630) of cloud (640, 640, 660, 680, 690). Here, the network segment granularity allows for a network deployment with static marking. Network discovery marking can be performed in a network segment in a manner that does not guarantee a high MTU marking. For example, the interfaces can be marked to serve most of the flows which are those markings with higher MTU such as (640-670) but allow for fragmentation for the smaller flows. The MTU discovery can be monitored over the interface and can be used to mark the smallest MTU allowed over the interface over time probabilistically. In this sense, an interest can carry MTU towards the content producer such as first it begins with no markings and eventually analyzes the flows and arrives at a distribution of MTU. The distribution favors larger MTU and can be used to mark the local interfaces and use the technique mentioned earlier to generate responses.

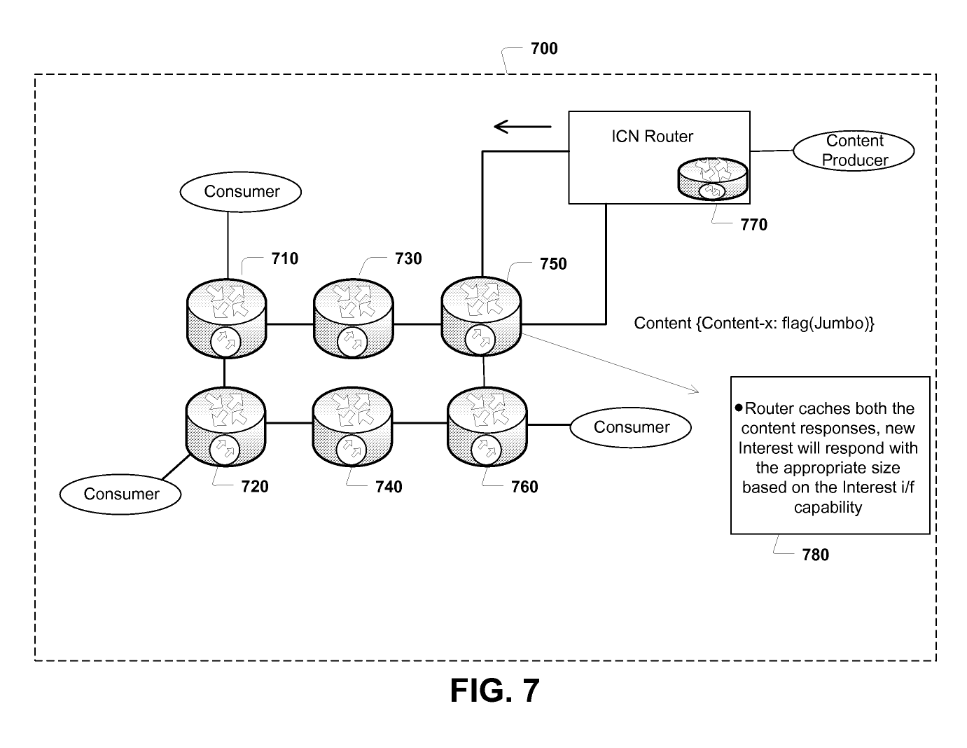

FIG. 7 illustrates a diagram (700) that describes caching implications where intermediate nodes (710-760) may cache multiple content responses based on i/f capabilities in accordance with embodiments of the present invention. Once the content responses are I/f capability encoded (780), intermediate caches depend on the interface capability fields of interest to respond to requests with appropriate content size. As a result, the reverse PIT table mapping will match both the name as well as the I/f capability field if it is supported. Furthermore, in this design the router (770) caches both the content responses, the newer interests when responding with the appropriate size based on the interest i/f capabilities (780).

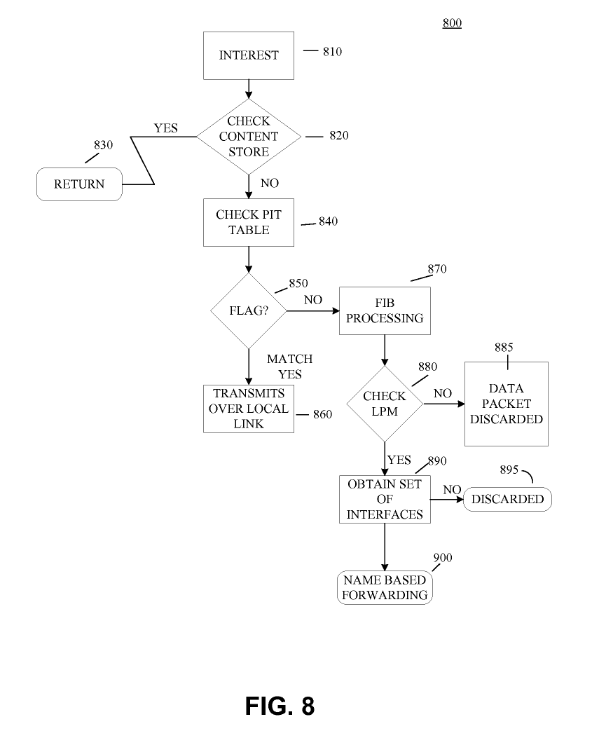

FIG. 8 show a diagram of the interest flow at the ICN router interface in accordance with embodiments of the present invention. Upon receiving an interest (step 810), a router first checks its local cache to see if a copy of the requested packet is available (step 820). If so, the router immediately transmits the data packet over the interest's incoming link (step 830). Otherwise, the router checks the PIT table (step 840) to see if an interest for the same data router has already been forwarded. If a PIT table entry exists, all packets in ICN will include a name. Users issue Interest packets specifying the desired content name and receive in response data packets with the corresponding content. Typically, for each interest, a user receives at most one data packet. Content names are variable-length hierarchical identifiers similar to file-system path names or URIs (e.g. /a/b/c.jpg). Interests are forwarded by routers toward content sources through hop by hop routing. As described herein, the ICN router interface will check its local cache to see if a copy of the requested packet is available. If so, the router will then immediately transmit the data packet over the interest's incoming link. Otherwise, the router will check the PIT table to see if there is an interest for the same data. Given that the network delivers only data that has been requested, unwanted traffic (e.g. spam) will be discarded near the source. Furthermore, maintaining per-packet forwarding state is an enabling factor for adaptive forwarding. Routers may exploit forwarding states to assist functions such as fast recovery from link failures, congestion avoidance and early detection of malicious users forwarded. Hence, when the interest comes in, there is a check at the content store (step 820) to see if there is a match with the content store. Next, the content is returned (step 830). In other words, the same content has already been requested or that someone else has requested the same content.

A check is performed to determine if the flag (step 850) is similar in the PIT table (step 840). If the answer is yes (step 860), then the interest is not forwarded but aggregated. If there is no match, the received interest (step 810) is treated as a new interest and sent to Forwarding Information Base (FIB) processing (step 870). The FIB, also known as a forwarding table, is most commonly used in network bridging, routing, etc., to find the proper interface to which the input interface should forward a packet. FIBs can be optimized for fast lookup of destination addresses and the FIB processing (step 870) performs a longest prefix match LPM (step 880), where additional ICN router interfaces are found and whereby the FIB processor (step 890) chooses an interface that matches a flag. Once matched, the interest is forwarded (step 900) or else it gets discarded (step 895). The flag enables similar content to be marked with the similar flags.

Embodiments of the present invention are thus described. While the present invention has been described in particular embodiments, it should be appreciated that the present invention should not be construed as limited by such embodiments, but rather construed according to the following claims.

What is claimed is:

1. A method for state based forwarding using an embedded flag in the type length values (TLV) architecture of an information centric network (ICN) interface, said method comprising:
storing, in static and dynamic fashions forward information for ICN router interfaces, the stored information is stored in a pending interest table (PIT) table associated with the ICN router interface,
setting a flag within the stored information in the TLV architecture of the ICN router interface, wherein the flag is associated with an interest capability of the ICN router interface;
receiving an interest associated with the flag;
checking a received interest with the stored information in the PIT table of the ICN router interface by using the flag associated with the interest to determine if the received interest matches a value of a flag of the PIT table associated to the received interest, and
forwarding the received interest if there exists no similar matching value in the PIT table to a content source.

2. The method of claim 1, further comprising:
marking with flags, interests associated with the router interfaces, said flags for identifying capabilities of the interests.

3. The method of claim 1, wherein the interests include MTU type network packets comprised of low, large, or jumbo MTU type packets associated by the flags.

4. The method of claim 1, further comprising:
mapping capabilities of the interests of the router interfaces for maximizing traffic transmission on the selected paths wherein the router interfaces includes ports marked as large, jumbo, or super jumbo.

5. The method of claim 2, further comprising:
relaying mappings of interest associated with the router interfaces for generating content responses.

6. The method of claim 5, further comprising choosing an appropriate size of the pre-produced content for generating the content response.

7. The method of claim 1, further comprising:
selecting a type length value (TLV) architecture of 2 bits for the flag for defining sizes of the MTU network packets for enabling heterogeneous types of router interfaces to support multiple types of applications for transmission.

8. A computer program product embodied in hardware and comprising non-transitory functional descriptive material imparting functionality to a computer, and which when executed by the computer, causes the computer to perform actions for a state based forwarding process using an embedded flag in the type length values (TLV) architecture of information centric network (ICN) interfaces, said method comprising: storing, in static and dynamic fashions forward information for ICN router interfaces, the stored information is stored in a pending interest table (PIT) table associated with the ICN router interface,
setting a flag within the stored information in the TLV architecture of the ICN router interface, wherein the flag is associated with an interest capability of the ICN router interface;
receiving an interest associated with the flag;
checking a received interest with the stored information in the PIT table of the ICN router interface by using the flag associated with the interest to determine if the received interest matches a value of a flag of the PIT table associated to the received interest, and
forwarding the received interest if there exists no similar matching value in the PIT table to a content source.

9. The computer program product of claim 8, wherein a same ICN packet primitive is configured for transmission through different MTU type networks ranging from low, large, or jumbo MTU type packets associated with flags.

10. The computer program product of claim 8, wherein the actions further comprise:
mapping capabilities of the interests of the router interfaces for maximizing traffic transmission on the selected paths wherein the router interfaces having ports marked as large, jumbo, or super jumbo.

11. The computer program product of claim 9, wherein the actions further comprise:
relaying mappings of interests associated with the router interfaces for generating content responses.

12. The computer program product of claim 12, wherein the actions further comprise:
provided if content of a content response is being pre-produced, choosing an appropriate size of the pre-produced content for generating the content response.

13. The computer program product of claim 8, wherein the actions further comprise:
choosing a type length value (TLV) architecture of 2 bits for the flag for defining sizes of the MTU network packets for enabling heterogeneous types of router interfaces to support multiple types of applications for transmission.

14. A data processing system comprising:
at least one processor;
data storage accessible to the at least one processor; and
a set of instructions in the data storage, wherein the at least one processor is operable to execute the set of instructions to perform actions for state based forwarding using an embedded flag in the type length values (TLV) architecture of information centric network (ICN) interfaces, the actions comprising:
storing, in static and dynamic fashions forward information for ICN router interfaces, the stored information is stored in a pending interest table (PIT) table associated with the ICN router interface,
using, a flag within the stored information in the TLV architecture of the ICN router interface wherein the flag is associated with an interest capability of the ICN router interface;
receiving, an interest associated with flag for forwarding at the ICN router interface,
checking, the received interest with the stored information in the PIT table of the ICN router interface by using the flag associated with the interest to determine if the received interest matches a value of a flag of the PIT table associated to an interest, and
forwarding, the received interest if there exists no similar matching value in the PIT table to a content source.

15. The data processing system of claim 15, the actions further comprise:
marking with flags, interests associated with the router interfaces, said flags for identifying capabilities of the interests.

16. The data processing system of claim 15, wherein the MTU type network packets compose low, large, or jumbo MTU type packets associated with the flags.

17. The data processing system of claim 15, wherein the actions comprise:
mapping capabilities of the interests of the router interfaces for maximizing traffic transmission on the selected paths wherein the router interfaces having ports marked as large, jumbo, or super jumbo.

18. The data processing system of claim 16, wherein the actions comprise:
relaying mappings of interest associated with the router interfaces for generating content responses.

19. The data processing system of claim 19 wherein the actions further comprise
choosing an appropriate size of the pre-produced content for generating the content response

20. The data processing system of claim 15, wherein the actions further comprise:
choosing a type length value (TLV) architecture of 2 bits for the flag for defining sizes of the MTU network packets for enabling heterogeneous types of router interfaces to support multiple types of applications for transmission. choosing a type length value (TLV) architecture of the MTU network packets for enabling heterogeneous types of router interfaces to support multiple types of applications for transmission.
